(19) United States
(12) Patent Application Publication
(10) Pub. No.: US 2017/0050810 A1
(43) Pub. Date: Feb. 23, 2017

(54) Device for Steadying Plastics Containers

(71) Applicant: M. TANNER AG, IlInau (CH)

(72) Inventor: Marcel TANNER, Bassersdorf (CH)

(73) Assignee: M. Tanner AG, llInau (CH)

(21) Appl. No.: 15/235,646

(22) Filed: Aug. 12, 2016

(30) Foreign Application Priority Data
Aug. 21, 2015 (CH) 01212/15

(51) Int. Cl. B65G 47/84; B29C 49/80; B29C 49/42

(52) U.S. Cl. CPC B65G 47/846; B29C 49/4205; B29C 49/80; B29K 2067/003

(57) ABSTRACT

A device for steadying parisons for plastics containers, in particular PET bottle parisons, in the entry region of an entraining device of an inspection unit having an overlaid part that has at least a first functional portion and a second functional portion. The second functional portion is arranged downstream of the first functional portion. The first functional portion damps, in particular, vertical disruptive movements of a parison that has been taken up by the entraining device such that the second functional portion comes into a substantially form-fitting guiding engagement with the parison, this guiding engagement bringing about complete steadying of the parison.

The invention relates to a device for steadying parisons for plastics containers, in particular PET bottle parisons, in the entry region of an entraining device such as a star wheel, an inspection unit and where applicable an ejector unit.

A corresponding inspection and ejector unit for parisons of this kind is known for example from EP 2 845 715 A1. This includes an entraining device, in the form of a star wheel that takes up parisons that arrive at the inspection and ejector unit from a feed device, transports them onward and passes at least some of the parisons on to a device for conveying them away. This inspection and ejector unit further includes a detection device in the form of a camera, by means of which faulty parisons in the star wheel are identified, and a reject device, by means of which parisons that have been identified as faulty are removed from the star wheel.

This inspection and ejector unit has proved its usefulness in practice; however, it has been found that at relatively high transport speeds (that is to say above approximately 30 000 parisons per hour) the parisons can start to wobble or vibrate on entering the star wheel, with the result that in some cases the camera cannot take clear images of the parisons that pass beside or below it, and thus there is a possibility that faulty parisons are not identified as such.

It is thus the object of the present invention to provide a device by means of which the parisons can be steadied, even at relatively high transport speeds, such that the camera of an inspection unit and where applicable an ejector unit can take images of the parisons without blurring.

This object is achieved according to the invention by means of a device for steadying parisons for plastics containers, in particular PET bottle parisons, in the entry region of an entraining device of an inspection unit, having: an overlaid part that has at least a first functional portion and a second functional portion, wherein the second functional portion is arranged downstream of the first functional portion, wherein the first functional portion damps in particular vertical disruptive movements of a parison that has been taken up by the entraining device such that the second functional portion comes into a substantially form-fitting guiding engagement with the parison, this guiding engagement bringing about complete steadying of the parison.

In the present document, the term “form-fitting guiding engagement” is used to mean that the parison can be guided or transported form-fittingly onward along the transport path by suitable devices, without jamming or wedging.

In the present document, the term “complete steadying” is used to mean that the parison no longer performs any disruptive movements, either in the vertical or the horizontal direction. Similarly, rotary and tilting movements of the parison are prevented.

The overlaid part (which is also called a steadying or holding-down block) is advantageously mounted on or above a guide rail that is arranged in a common plane with and alongside the entraining device (that is to say, typically a star wheel).

The overlaid part advantageously has in the first functional portion devices that leave the parison, in particular in the vertical direction, only a small amount of play (or decreasing play) in relation to the underside of a cover plate of the overlaid part.

In the second functional portion, as mentioned above the overlaid part advantageously has devices that preferably come into a form-fitting guiding engagement with the support ring of the parison, with the result that the parison can be guided onward without any further wobbling or disruptive movement. The camera of the inspection unit can then record sharp images of the parison and reject defective parisons with a high degree of reliability.

By means of the device according to the invention, transport speeds of more than 50 000 parisons per hour can be achieved without problems arising in respect of the quality of the images of parisons that are transported past the camera.

In a preferred embodiment of the present invention, the overlaid part has a cover plate that extends over the first and the second functional portion. The cover plate preferably has a length (L) that corresponds to at least twice the support ring diameter of a parison and a width (B) that corresponds to at least one to 1.5 times the width of the support ring diameter. These dimensions have proved particularly suitable in practice, since they are sufficient to bring about complete steadying of the parisons, the overlaid part can be given a form that saves on space, and where appropriate no or only small adjustments are needed to a curved transport path of the parisons.

In a further preferred embodiment of the present invention, two side walls jut (perpendicularly) from the cover plate, in particular in the region of the second functional portion, and preferably each have at their lower end a (horizontally) inwardly directed projection, such that the second functional portion has a cross section substantially in the shape of a C-profile. The support rings of the parisons pass through below these projections or this C-profile, while the mouth of each parison passes through the interior space defined by the C-profile.

In a further preferred embodiment of the present invention, the side edges of the projections run parallel to the side walls, or they have a curvature. With the length (L) of the cover plate that was specified above (and that typically also corresponds to the overall length of the overlaid part), a straight construction of the projections is sufficient, without hindering transport of the parisons along the curved path of the star wheel. However, it is of course also possible to adapt the projections to the peripheral curvature of the star wheel or to a guide rail that runs in a manner corresponding thereto (and on which the support rings of the parisons also partly lie). This is in particular useful if a relatively long embodiment of the overlaid part is selected. The projections, or their side edges, serve to guide the parisons laterally (that is to say in the region of the mouth above the support ring) and help to suppress lateral disruptive and rotary movements.

In a further preferred embodiment of the present invention, there is arranged, at least on a side wall of the overlaid part, a mounting portion by means of which the overlaid part may be secured to a guide device of the inspection unit. The mounting portion preferably takes the form of a block-like structure having a bore that passes right through it, for receiving a securing device (such as a screw). Further preferably, the bore takes the form of an elongate bore in order to enable the overlaid part to be mounted with as much capacity for variation as possible.

In a further preferred embodiment of the present invention, the mounting portion has on its underside a three-point bearing. Preferably, the three-point bearing is milled into the underside of the mounting portion. It serves on the one hand to ensure that the overlaid part does not rotate when the screw is tightened during mounting of the overlaid part on the guide rail. On the other hand, by means of the three-point bearing the required spacing is also provided between the underside of the (inwardly directed) projections and the upper side of the guide rail such that the support rings can be guided in between (and in particular held down) without nonetheless jamming. For this reason, the spacing is typically somewhat larger than the thickness of the support ring of a parison.

In a further preferred embodiment of the present invention, the cover plate has a shoulder on its underside, in the region of the second functional portion, wherein the spacing from the mouth opening of the parison to the underside of the cover plate is larger in the region downstream of the shoulder than in the region upstream of the shoulder (however, this is not imperative for the region of the first guide portion, which has the chamfer that is described below). As seen in cross section, the shoulder occurs after about ⅕ of the length of the second functional portion, preferably after about ¼ of the length of the second functional portion and further preferably after about ⅓ of the length of the second functional portion (in each case as seen in the direction of transport). The purpose of this measure is to prevent the parison, as it leaves the overlaid part or the second functional portion of the overlaid part, from catching, by means of its mouth opening, on the underside of the cover plate and tilting. This would once again have the result that the parison would strike against other parisons and possibly result in a disruption to operation in the inspection unit.

In a further preferred embodiment of the present invention, the cover plate has a chamfer on its underside, in particular in the region of the first functional portion. The chamfer is intended to prevent the parisons from striking against the front or entry edge of the cover plate as they enter the overlaid part and thus resulting in a blockage in the entry region of the inspection unit. The chamfer has an angle α of between 10° and 45°, preferably between 15° and 40° and further preferably between 20° and 35°.

In a further preferred embodiment of the present invention, the overlaid part is milled out of a block.

This type of manufacture has proved to be particularly precise and low in cost. In practice, it has moreover proved favorable when converting to a different size of parison to have overlaid parts that are milled to appropriate dimensions immediately to hand. In principle, however, an adjustable construction of the overlaid part is also conceivable (that is to say having for example an adjustable incline, length and/or width).

In a further preferred embodiment of the present invention, the cover plate has a viewing opening. The latter serves primarily to monitor operation. Instead of a viewing opening, however, it is also possible for a mounting bore for additional securing elements and/or structural elements to be provided (for example where there is an adjustable construction of the overlaid part).

In yet a further preferred embodiment of the present invention, the entraining device includes a star wheel.

Typically, a guide rail runs at an unchanging spacing therefrom, in a manner corresponding thereto (that is to say as an additional support face for the support ring).

An exemplary embodiment of the present invention will be illustrated with reference to the attached drawings for the purpose of better clarity.

In the drawings:

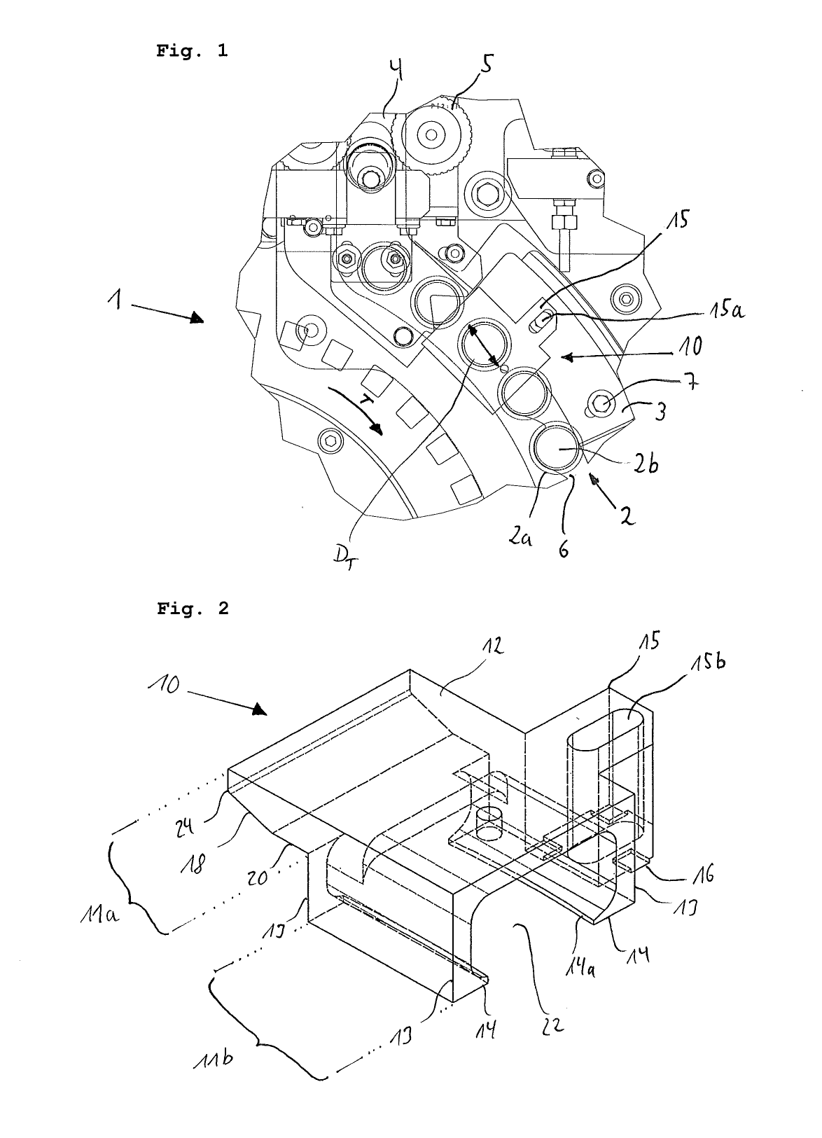

FIG. 1 shows a detail view comprising an inspection unit having a device according to the invention that is arranged in the entry region of the star wheel;

FIG. 2 shows a perspective view of a device according to the invention;

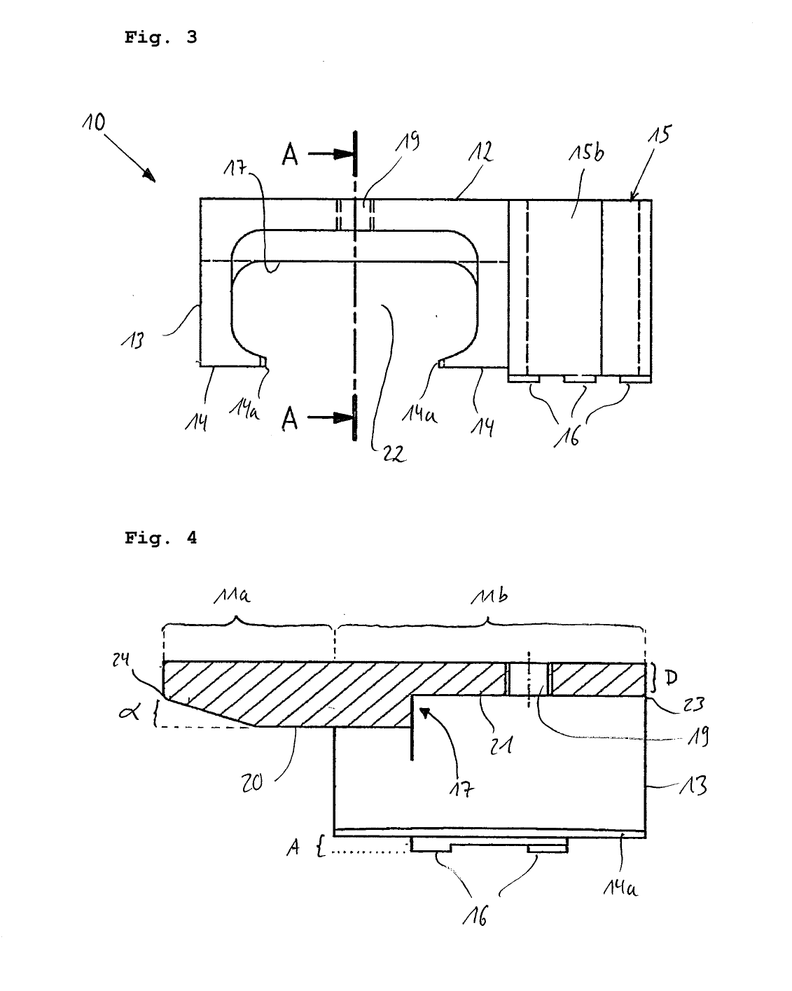

FIG. 3 shows a front view of a device according to the invention, according to FIG. 2;

FIG. 4 shows a sectional view of the device according to the invention, along the line A-A according to FIG. 3;

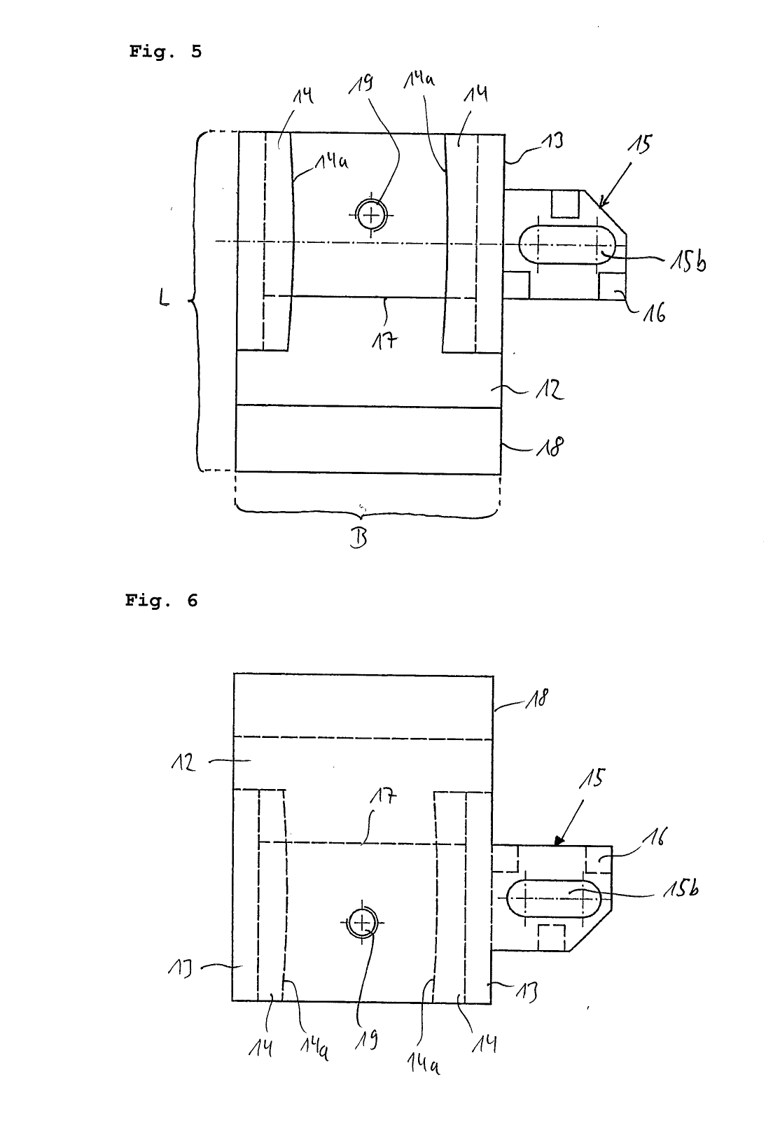

FIG. 5 shows a bottom view of a device according to the invention, according to FIG. 2; and

FIG. 6 shows a top view of a device according to the invention, according to FIG. 2.

FIG. 1 shows a detail view comprising an inspection unit having an overlaid part 10 according to the invention that is arranged in the entry region of the star wheel 1. The parisons 2 are transported to the star wheel 1 of the inspection unit by way of a feed device 4 (that is to say, typically a feed rail) and are taken up there by a corresponding transport cutout 6 in the star wheel 1. The feed device 4 may moreover be converted to other sizes of parison by way of the likewise illustrated adjusting device 5.

The overlaid part 10 according to the invention is typically arranged very close to the point at which the parisons 2 enter the star wheel 1, in order to steady them as soon as possible for the camera of the inspection unit (which is not illustrated), which is arranged (relatively close) downstream. As can be seen, approximately two parisons 2 pass through the overlaid part 10 at the same time. By means of a mounting portion 15 and a corresponding securing device, the overlaid part 10 is arranged on a guide device 3 (typically a guide rail) on which there is guided a part of the support ring 2a of each parison 2 that does not lie on the upper side of the transport cutout 6.

The diameter D_{T} of the support ring 2a is, as is conventional, larger than that of the mouth opening 2b of the parison 2. The guide rail 3 has a peripheral curvature that corresponds to that of the star wheel 1. The guide rail 3 is mounted, for example by means of screws 7, on a frame part of the inspection unit, it being possible to convert the guide rail 3 to another size of parison, similarly to the feed device 4. The arrow T moreover indicates the direction of transport.

The overlaid part 10 according to the invention is illustrated more closely in FIG. 2. From left to right, that is to say as seen in the direction of transport T, there are visible first the cover plate 12 with the entry edge 24 (cf. also FIG. 4), the chamfer 18 and the horizontal underside 20 adjoining it (or the outer part thereof that extends as far as the side walls 13) of the cover plate 12. This portion of the overlaid part 10 comprises the first functional portion 11a, which brakes or damps in particular initially vertical disruptive movements (that is to say wobbling or vibrational movements caused in particular by impact at relatively high transport speeds) of a parison 2 that has been taken up by the entraining device (that is to say that is coming from the feed device 4) by providing, in the vertical direction for the parison 2 or the mouth thereof, play that becomes smaller and smaller until it reaches the horizontal underside 20 and finally, in the horizontal region of the underside 20, remains at an initially constant small size (for example in the region of a few millimeters or even a few tenths of a millimeter).

The side walls 13, which jut vertically downward from the cover plate 12 and have the inwardly directed projections 14, then form the second functional portion 11b of the overlaid part 10 according to the invention. Here, the parison 2 comes into a substantially form-fitting guiding engagement that has the effect of holding the parison 2 completely down or steady. The guiding engagement for the parison 2 or the support ring 2a thereof is, in the present case, constructed between the undersides of the projections 14 and the upper side of the guide rail 3 (cf. FIG. 1).

Provided on a side wall 13 of the overlaid part 10 (that is to say preferably on the outwardly directed side wall 13) is the block-shaped mounting portion 15, which may be mounted adjustably on the guide rail 3 by means of the mounting or elongate bore 15b and a suitable securing device. Provided on the underside of the mounting portion 15 is a three-point bearing 16. In the region of the second functional portion 11b, the cover plate 12, the side walls 13 and the projections 14 define the interior space 22 through which the mouths of the parisons 2 (that is to say the portions above the support ring 2a) pass.

FIG. 3 illustrates a front view of the overlaid part 10 according to the invention, according to FIG. 2. The cover plate 12 and the side walls 13 that jut therefrom and have the inwardly directed projections 14 define the interior space 22, as stated above. Moreover, in the upper region of the interior space 22 there is visible a shoulder 17, whereof the purpose will be explained in more detail below in conjunction with FIG. 4. In the central region of the cover plate 12 there is also arranged an opening 19. This may be a viewing opening for monitoring operation, or indeed a threaded bore for attaching further structural elements or for further securing of the overlaid part 10.

Once again, the mounting portion 15 is visible, with the elongate bore 15b and the three-point bearing 16 that is arranged on its underside, for twist-free mounting of the overlaid part 10 on the guide rail 3. The side edges 14a of the projections 14 are conventionally constructed to be perpendicular, as can be seen. They ensure lateral guidance of the parisons (that is to say in the region of the mouth, above the support ring 2a) and moreover contribute to damping or suppressing lateral disruptive and rotary movements.

FIG. 4 illustrates a sectional view of the overlaid part according to the invention along the line A-A according to FIG. 3. Here there is again visible the construction of the first functional portion 11a, with the chamfer 18 (cf. FIG. 2), which forms an angle a of between 10° and 45°, preferably between 15° and 40° and further preferably between 20° and 35°. The transition from the first functional portion ha to the second functional portion 11b typically takes place at the point where the side walls 13 jut from the horizontal underside 20 of the cover plate 12. As can be seen, however, the horizontal underside 20 also extends somewhat further into the region of the second functional portion 11b, by about ⅕ to ⅓ of the overall length of the second functional portion 11b. At the point at which the horizontal underside 20 ends there is a shoulder 17, which gives the parison 2 and its mouth opening more play (that is to say by comparison with the horizontal underside of the cover plate 21 downstream of the shoulder 17) than before.

This serves the purpose of ensuring that when the parison 2 leaves the overlaid part 10 it does not catch by means of its mouth or its mouth opening 2b on the exit edge 23 of the cover plate 12 at the end of the second functional portion 11b and cause the parison 2 to tilt and possibly strike against the upstream or downstream parisons 2. By means of the shoulder 17, disruptions to operation of this kind can be reliably avoided. The horizontal underside of the cover plate 21 downstream of the shoulder 17 is typically somewhat longer than the diameter D_{T} of the support ring 2a of a parison 2.

In the region downstream of the shoulder 17, the thickness D of the cover plate 12 is only around half the thickness it had in the region of the horizontal underside 20. Moreover, again visible is the opening 19, constructed as a threaded bore, and the side edge 14a of the projection 14 that juts inward from the side wall 13.

On the underside of the mounting block 15 there is again visible the three-point bearing 16 and the spacing A that is formed by the three-point bearing from the underside of the projection 14. This spacing A is dimensioned such that there may be formed with the support ring 2a of a parison 2 a substantially form-fitting guiding engagement that on the one hand reliably and entirely holds down or steadies the parison and on the other hand causes no jamming or wedging of the parison 2 during transport. An additional three-point bearing 16 (or a corresponding support) may where applicable also be provided on the underside of the opposing side wall 13.

FIG. 5 shows a bottom view of an overlaid part 10 according to the invention. Visible here are the dimensions of the cover plate 12, namely the length L and the width B. The ratio L:B is preferably around 5:2, particularly preferably around 5:3 and yet further preferably 5:4. Moreover, FIG. 5 shows that the projections 14 or the side edges 14a of the projections 14 may take a curved line. This line typically follows the peripheral curvature of the star wheel 1 and the guide rail 3 and where applicable serves to ensure unhindered passage of the parison 2 through the overlaid part 10. Finally, FIG. 6 shows a corresponding top view of an overlaid part 10 according to the invention, with curved projections 14 or side edges 14a.

In the present description, moreover, like reference numerals designate the same components throughout.

### LIST OF REFERENCE NUMERALS

1 Entraining device (star wheel)

2 Parison

2a Support ring

2b Mouth opening

3 Guide device (guide rail)

4 Feed device

5 Adjusting device

6 Transport cutout (of star wheel)

7 Screw

10 Overlaid part

11a First functional portion

11b Second functional portion

12 Cover plate

13 Side walls

14 Projections

14a Side edges

15 Mounting portion

15a Securing device

15b Mounting bore

16 Three-point bearing

17 Shoulder

18 Chamfer

19 Viewing opening

20 Horizontal underside of cover plate (upstream of shoulder)

21 Horizontal underside of cover plate (downstream of shoulder)

22 Interior space

23 Exit edge

24 Front edge (entry edge)

A Spacing

B Width

D Thickness

D_{T} Diameter of support ring

L Length

T Direction of transport

α Angle of chamfer

1. A device for steadying parisons for plastics containers, in particular PET bottle parisons, in the entry region of an entraining device (1) of an inspection unit, comprising:
an overlaid part (10) that has at least a first functional portion (11a) and a second functional portion (11b), wherein the second functional portion (11b) is arranged downstream of the first functional portion (11a), wherein the first functional portion (11a) damps in particular vertical disruptive movements of a parison (2) that has been taken up by the entraining device (1) such that the second functional portion (11b) comes into a substantially form-fitting guiding engagement with the parison (2), this guiding engagement bringing about complete steadying of the parison (2).

2. The device as claimed in claim 1, wherein the overlaid part (10) has a cover plate (12) that extends over the first and the second functional portion (11a, 11b).

3. The device as claimed in claim 1, wherein the cover plate (12) has a length (L) that corresponds to at least twice the support ring diameter (D_{T}) of a parison (2) and a width (B) that corresponds at least to once the width of the support ring diameter (D_{T}).

4. The device as claimed in claim 1, wherein two side walls (13) jut from the cover plate (12), in particular in the region of the second functional portion (11b), and preferably each have at their lower end an inwardly directed projection (14), such that the second functional portion (11b) has a cross section substantially in the shape of a C-profile.

5. The device as claimed in claim 4, wherein the inwardly directed projections (14) jut substantially horizontally from the side walls (13).

6. The device as claimed in claim 4, wherein the side edges (14a) of the projections (14) run parallel to the side walls (13), or they have a curvature.

7. The device as claimed in claim 1, wherein there is arranged, at least on a side wall (13) of the overlaid part (10), a mounting portion (15) by means of which the overlaid part (10) may be secured to a guide device (3) of the inspection unit.

8. The device as claimed in claim 7, wherein the mounting portion (15) has a bore (15b) for a securing device (15a).

9. The device as claimed in claim 7, wherein the mounting portion (15) has on its underside a three-point bearing (16).

10. The device as claimed in claim 9, wherein the three-point bearing (16) is constructed such that in the mounted condition the inwardly directed projections (14) of the side walls (13) jut by means of their underside from the upper side of the guide device (3) of the inspection unit, wherein preferably the corresponding spacing (A) corresponds at least to the thickness of the support ring (2a) of a parison (2).

11. The device as claimed in claim 1, wherein the cover plate (12) has a shoulder (17) on its underside, in the region of the second functional portion (11b), wherein the spacing from the mouth opening (2b) of the parison (2) to the underside of the cover plate (12) is larger in the region downstream of the shoulder (17) than in the region upstream of the shoulder (17).

12. The device as claimed in claim 1, wherein the cover Plate (12) has a chamfer (18) on its underside, in particular in the region of the first functional portion (11a).

13. The device as claimed in claim 1, wherein the overlaid part (10) is milled out of a block.

14. The device as claimed in claim 1, wherein the cover plate (12) has a viewing opening (19).

15. The device as claimed in claim 1, wherein the entraining device includes a star wheel (1).
